(19) United States
(12) Patent Application Publication
(10) Pub. No.: US 2005/0079039 A1
(43) Pub. Date: Apr. 14, 2005

(54) Industrial type cart

(76) Inventors: John R. Neumann, Painesville, OH (US); Daniel S. Zenisek, Warrensville Heights, OH (US)

Correspondence Address: James A. Hudak, Esq., Suite #304, 29425 Chagrin Blvd., Cleveland, OH, 44122-4602, US

(21) Appl. No.: 10/685,142

(22) Filed: Oct. 14, 2003

(51) Int. Cl. B60P 1/00

(52) U.S. Cl. 414/529

(57) ABSTRACT

An industrial type cart that has a rotatable and indexable top surface that supports a roller conveyor arrangement and which can be towed using a standard tug, automatic guided vehicle or human power is disclosed. The cart is comprised of a base member, a frame member, and rotation apparatus permitting the indexable rotation of the frame member with respect to the base member. An inner ring is attached to the top surface of the base member and an outer concentric ring is attached to the bottom surface of the frame member. A shoulder bolt is received through a cross member attached to the outer concentric member and is received within a threaded bore provided in a cross member attached to the inner ring on the base member permitting the frame member to rotate relative to the base member. A spring loaded indexing device is attached to the base member and engages a pair of a plurality of flanged surfaces that are attached to and angularly spaced around the outer concentric ring on the frame member permitting the indexable engagement of the frame member with respect to the base member as the frame member is rotated with respect to the base member. The roller conveyor arrangement, which can have a number of configurations, is attached to the top surface of the frame member.

### TECHNICAL FIELD

The present invention relates, in general, to an industrial type cart and, more particularly, to an industrial type cart having a roller conveyor arrangement attached to a frame member that is rotatably indexable with respect to the base member of the cart.

### BACKGROUND ART

Various types of vehicles are available to transport loads within an industrial facility. Typically, such vehicles comprise various types of forklift trucks. These trucks have outwardly extending forks that are received within pallets, which support the load. The forks lift the pallet with the load thereon to transport same from one location to another location within the industrial facility. Such forklift trucks are rather costly to acquire and maintain. In addition, they are somewhat unsafe to operate and have been the cause of injury to individuals in the vicinity of the trucks. In view of foregoing, it has become desirable to develop an industrial type cart that replaces forklift trucks and has a rotatable and indexable frame member having a roller conveyor arrangement thereon and which can transport loads using standard tugs, automatic guided vehicles or human power.

### SUMMARY OF THE INVENTION

The present invention solves the problems associated with prior art industrial type trucks, and other problems, by providing a relatively inexpensive industrial type cart comprising a base member, a frame member having a roller conveyor arrangement thereon, and rotation apparatus permitting the indexable rotation of the frame member with respect to the base member. The aforementioned rotation apparatus includes an inner ring attached to the top surface of the base member and an outer concentric ring attached to the bottom surface of the frame member. A shoulder bolt is received through a cross member attached to the outer concentric ring and is threadably received within a bore provided in a cross member attached to the inner ring on the base member permitting the frame member to rotate relative to the base member. A spring loaded indexing device is attached to the base member and engages flanged surfaces attached to the outer concentric ring on the frame member permitting the indexable engagement of the frame member with respect to the base member as the frame member is rotated relative to the base member. The roller conveyor arrangement can have any one of a number of configurations, such as an H-shaped configuration, and is attached to the top surface of the frame member. In addition, a dunnage retention system is provided to retain a load on the roller conveyor arrangement. Alternatively, a flat base plate that is rotatably indexable with respect to the base member can replace the roller conveyor arrangement and the frame member.

### BRIEF DESCRIPTION OF THE DRAWINGS

FIG. 1 is a perspective view of the industrial type cart of the present invention.

FIG. 2 is a perspective view of the base member of the industrial type cart of the present invention.

FIG. 3 is a top plan view of the industrial type cart of the present invention with the frame member and roller conveyor arrangement removed therefrom.

FIG. 4 is a side elevational view of the industrial type cart of the present invention.

FIG. 5 is a rear elevational view of the industrial type cart of the present invention.

FIG. 6 is a top plan view of the inner ring and the outer concentric ring used for rotating the frame member with respect to the base member of the industrial type cart of the present invention and illustrates the spring loaded indexing device in the engaged condition.

FIG. 7 is a top plan view of the inner ring and the outer concentric ring used for rotating the frame member with respect to the base member of the industrial type cart of the present invention and illustrates the spring loaded indexing device in the non-engaged condition.

FIG. 8 is a cross-sectional view taken across section-indicating lines 8-8 in FIG. 7 and illustrates the spring loaded indexing device in the non-engaged condition.

FIG. 9 is a cross-sectional view similar to FIG. 8 and illustrates the spring loaded indexing device in the engaged condition.

FIG. 10 is a cross-sectional view of the spring loaded indexing device taken across section-indicating lines 10-10 in FIG. 8.

FIG. 11 is a cross-sectional view taken across section-indicating lines 11-11 in FIG. 7 and illustrates the mounting of the roller bearing to the inner ring and the rolling engagement of the surface of the roller bearing with the outer concentric ring.

FIG. 12 is a perspective view of the bottom of the frame member and illustrates the dunnage retainers that are adjacent the oppositely disposed ends of outer roller conveyor sections when the dunnage retainers are in their upright position to retain a load that spans the outer roller conveyor sections and the inner roller conveyor section interposed there between.

FIG. 13 is a perspective view similar to FIG. 12 and illustrates the dunnage retainers that are adjacent the oppositely disposed ends of the outer roller conveyor sections when the dunnage retainers are in the horizontal position permitting a load to be placed on or removed from the roller conveyor arrangement.

FIG. 14 is a perspective view of the top surface of the roller conveyor arrangement and illustrates the dunnage retainers that are adjacent the oppositely disposed ends of the inner roller conveyor section in their engaged and disengaged positions.

### DESCRIPTION OF THE PREFERRED EMBODIMENT

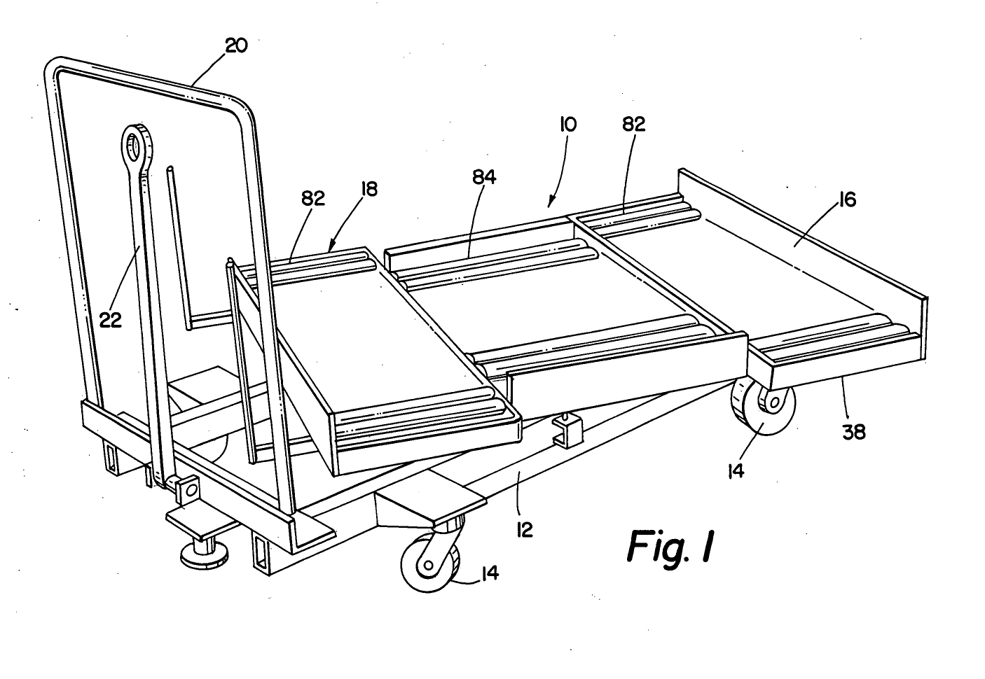

Referring now to the Figures where the illustrations are for the purpose of describing the preferred embodiment of the present invention and are not intended to limit the invention described herein, FIG. 1 is a perspective view of the industrial type cart 10 of the present invention. The cart 10 is comprised of a base member 12, a wheel 14 adjacent each end of the base member 12, a frame member 16 supported by the base member 12, a roller conveyor arrangement 18 supported by the frame member 16 and a handle 20 attached to one end 22 of the base member 12. A tow bar 24 is also attached to end 22 of base member 12 and is biased by a spring (not shown) so as to be in the upright position and to be readily available to the operator of the cart 10. Thus, the operator of the cart 10 does not have to bend to grasp the tow bar 24.

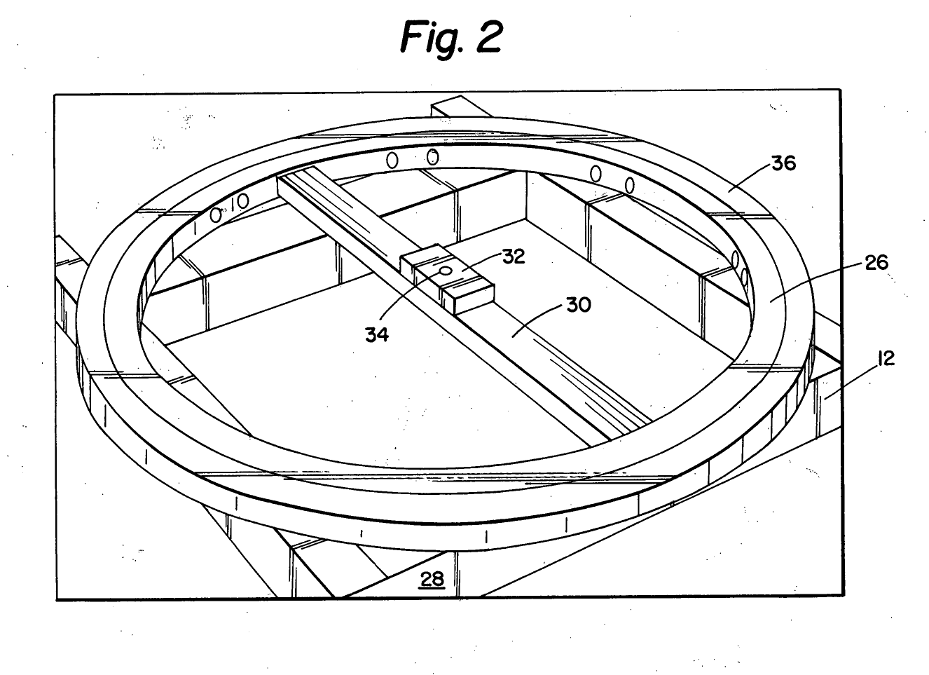

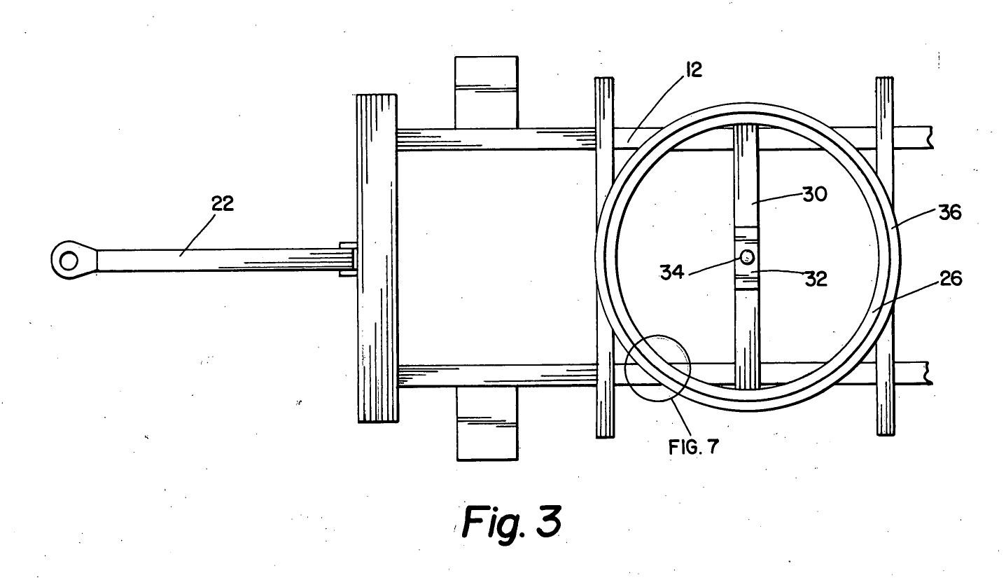

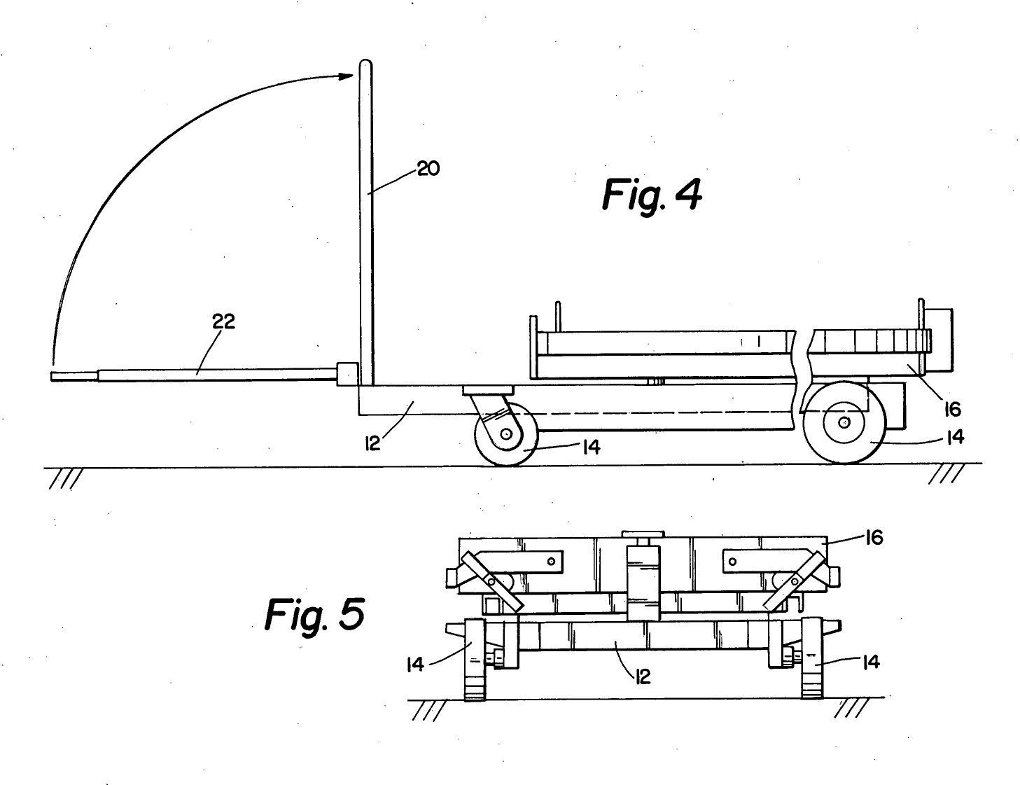

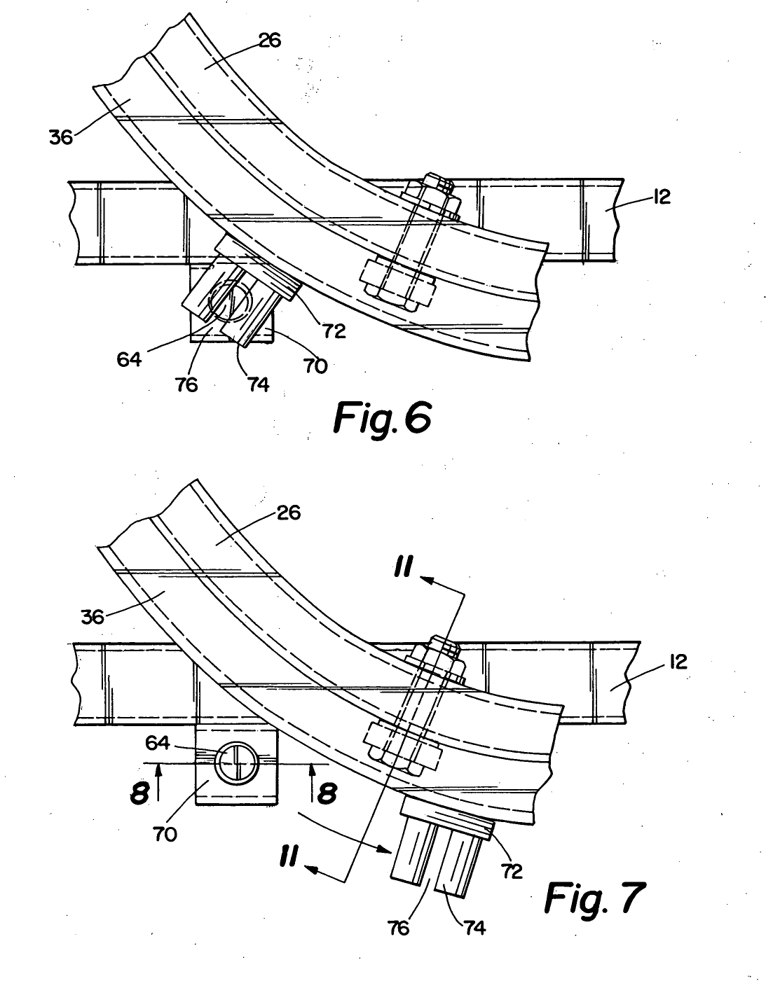

The base member 12 is typically rectangular in overall configuration, as shown in FIG. 2, and has a circular inner ring 26 mounted to the top surface 28 thereof and in the approximate center thereof. The inner ring 26 typically has a square tubular configuration, as shown in FIG. 11. A cross member 30 is attached to and positioned along a diameter of the inner ring 26. A mounting block 32 is mounted in the approximate center of the cross member 30 and has a threaded bore 34 therein and within cross member 30.

The wheels 14 are typically positioned under the base member 12 so as to minimize the possibility of the operator of the cart 10 tripping over same when walking around the cart 10. The wheels 14 are mounted asymmetrically around the cart 10 such that the wheels 14 adjacent the rear of the cart 10 support about 70% of the load on the cart 10 and the wheels 14 adjacent the front of the cart 10 support about 30% of the aforementioned load. The wheels 14 adjacent the front of the cart 10 are harder (have a higher Durometer) than the wheels 14 adjacent the rear of the cart 10. The use of a higher Durometer material for the wheels 14 adjacent the front of the cart 10 minimizes wheel compression under load thus reducing friction during sharp turns, e.g. 90 degree turns, and increases the maneuverability of the cart 10. The use of a lower Durometer material for the wheels 14 adjacent the rear of the cart 10 minimizes the skidding of same when under load.

The frame member 16 includes a shoulder bolt (not shown) that is received within a bore in a cross member (not shown) attached to an outer ring 36, shown in FIG. 2, that is attached to the bottom surface 38 of the frame member 16. The shoulder bolt is threadably received within threaded bore 34 in mounting block 32 and cross member 30 permitting the frame member 16 to be rotatable with respect to the base member 12. The outer ring 36 is typically circular in configuration and is formed from L-shaped angle iron. The diameter of outer ring 36 is slightly greater than the diameter of inner ring 24. The outer ring 36 is concentric with the inner ring 24 and is rotatable with respect thereto. As shown in FIG. 11, roller bearings 40 are received on bolts 42 whose shanks 44 are received through inner ring 24 and are positioned thereon so as to be outboard of the inner ring 24 and interposed between a washer 46 and the head 48 of the bolt 42 on which they are received. The outer surface of each roller bearing 40 contacts the inner surface 50 of the outer ring 36. Each bolt 42 is secured by a washer 52 and a nut 54.

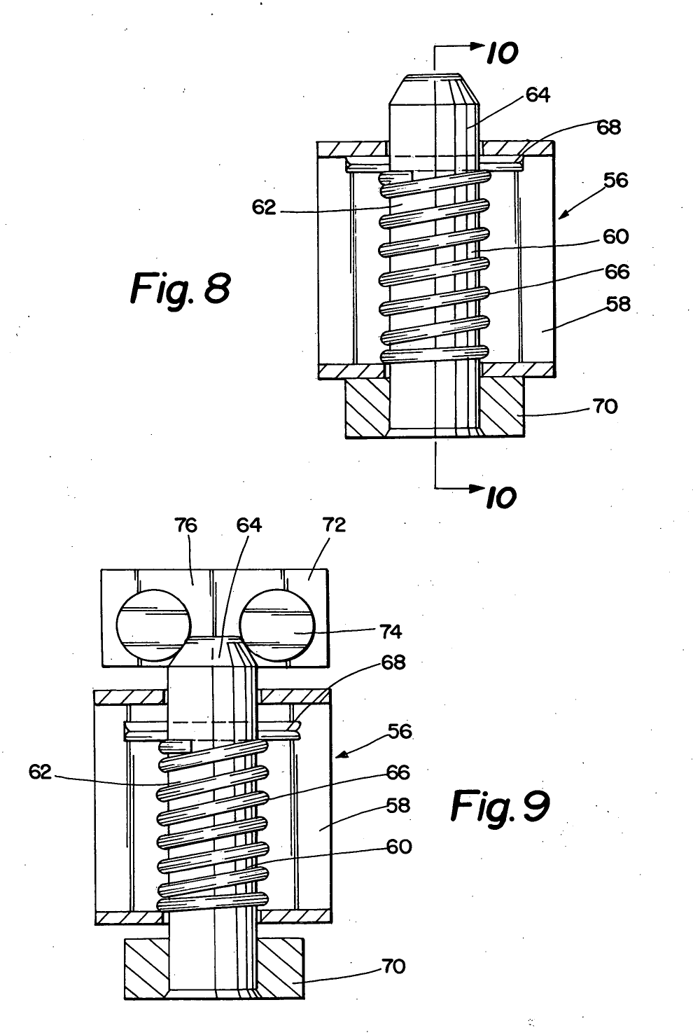

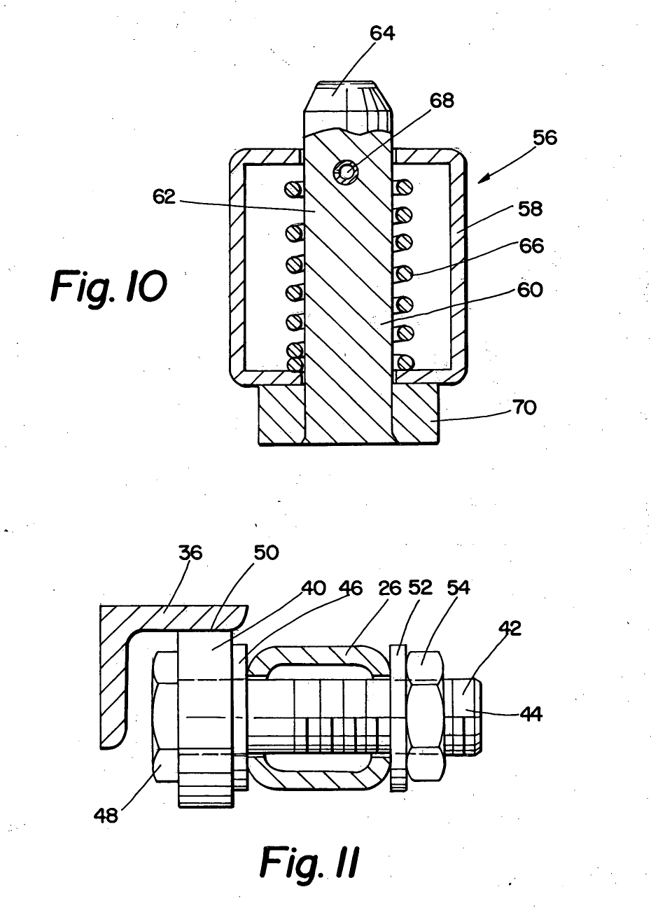

A spring loaded indexing device 56, as shown in FIGS. 8, 9 and 10, is positioned adjacent outer ring 36 and is attached to base member 12. The spring loaded indexing device 56 is comprised of a housing 58, a pin 60 having its shank 62 received within the housing 58 and positioned therein so that its tip 64 protrudes outwardly therefrom, a spring 66 which biases the pin 60 within the housing 58 and a roll pin 68 which biases the spring 66 within the housing 58. The housing 58 is attached to the base member 12 by means of a bracket 70. A plurality of brackets 72 are attached to the outer ring 36 and include outwardly spaced-apart flanges 74. Typically, the brackets 72 and outwardly spaced-apart flanges 74 are positioned at 90-degree increments around the outer ring 36. The gap 76 between the spaced-apart flanges 74 is sufficient so as to receive the tip 64 of the pin 60.

Various types of roller conveyor arrangements 18 can be attached to the frame member 16 so as to support a load thereon. Referring to FIG. 1, a roller conveyor arrangement 80 comprising two outer roller conveyor sections 82 with an inner roller conveyor section 84 interposed therebetween and in a spaced-apart relationship with respect to the outer roller conveyor sections 82 is illustrated. In this case, the overall length of the two outer roller conveyor sections 82 is greater than the overall length of the inner roller conveyor section 84 forming a H-shaped configuration for the roller conveyor arrangement 80. The H-shaped configuration of the roller conveyor arrangement 80 permits the entry of a person into the space between the two outer roller conveyor sections 82 so as to retrieve parts on a pallet on the roller conveyor arrangement 80. Thus, the H-shaped configuration of this roller conveyor arrangement 80 takes into consideration ergonomic factors relating to the retrieving of a small pallet from the surface of the roller conveyor arrangement 80. Alternatively, the length of the three roller conveyor sections can be the same without any spaces therebetween. Such a roller conveyor arrangement would be utilized for a smaller roller conveyor surface. In addition, the frame member 16 and the roller conveyor arrangement 18 can be replaced by a solid base plate. In any event, the roller configuration arrangement or base plate would be rotatable with respect to the base member 12 of the cart 10 and can be rotatably indexed by the spring loaded indexing device 56 attached to the base member 12.

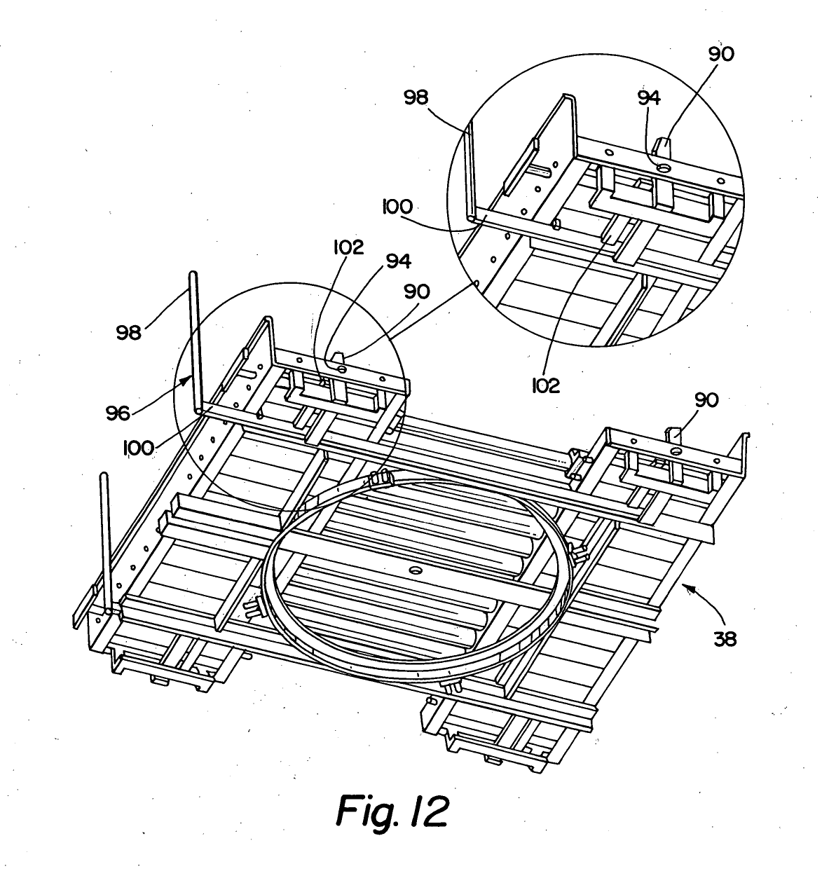

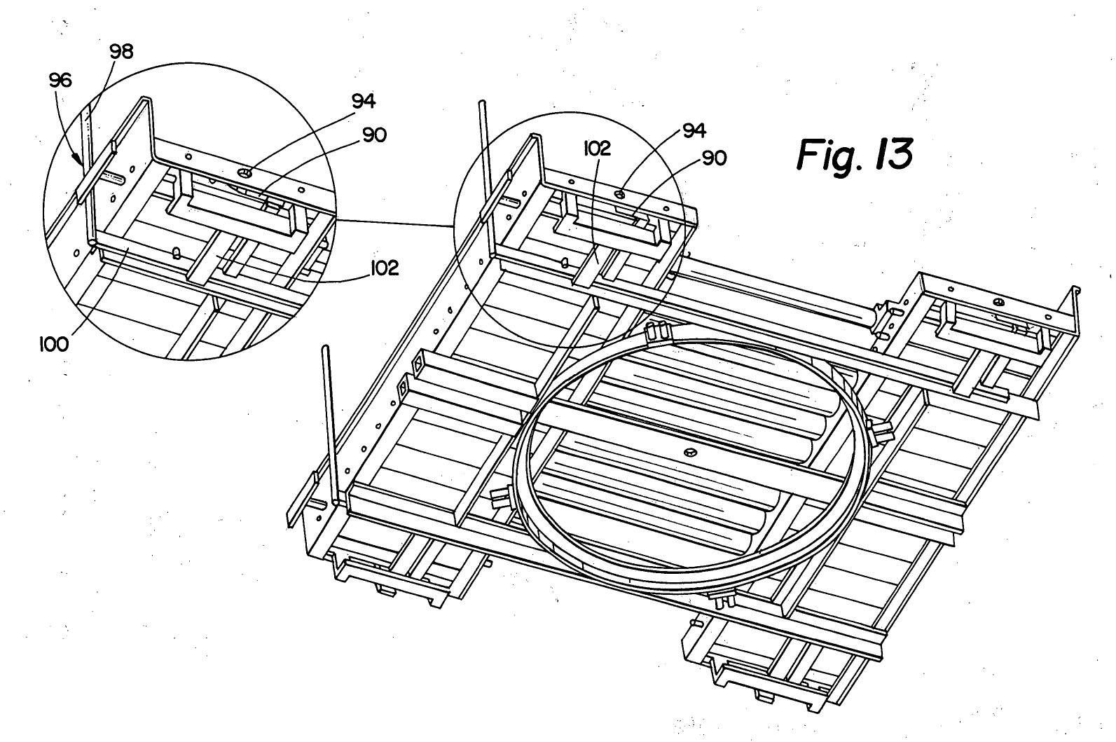

A dunnage retainer 90 is positioned adjacent the oppositely disposed ends of the two outer roller conveyor sections 82 and a separate dunnage retainer 92 is positioned adjacent the oppositely disposed ends of the inner roller conveyor section 84. Referring now to FIG. 12, the bottom 38 of the frame member 16 is illustrated and shows the dunnage retainers 90 in their upright position preventing a load on the roller conveyor arrangement 18 from slipping off of same. The dunnage retainers 90 comprise a bar member pivotally attached to the frame member 16 by means of a pin 94. The dunnage retainers 90 are designed such that they are normally in the upright position. A dunnage retainer actuating linkage 96 is provided to rotate the dunnage retainers 90 into the horizontal position, as shown in FIG. 13, permitting a load on the roller conveyor arrangement 18 to be placed on or removed from same. The dunnage retainer actuating linkage 96 comprises an upright member 98 attached at one end thereof to a sliding bar member 100 having an actuating arm 102 transversely mounted thereto. The sliding bar member 100 is slidingly attached to the bottom surface 38 of the frame member 16 and is positioned inwardly of the ends of inner roller conveyor section 84 so that the operator of the cart 10 can place loads onto and/or remove loads from the inner roller conveyor section 84 without hitting same. As previously stated, the dunnage retainers 90 are normally in the upright position unless a load is being placed on or being removed from the roller conveyor arrangement 18. In order to rotate the dunnage retainers 90 into the horizontal position, the operator of the cart 10 pushes the upright member 98 toward the rear of the cart 10 causing the sliding bar 100 to similarly move toward the rear of the cart 10 resulting in the actuating arm 102 attached to the sliding bar 100 to engage the dunnage retainer 90 rotating same into the horizontal position. In order to cause the dunnage retainers 90 to return to their normal upright position, the operator of the cart 10 pulls the upright member 98 toward the front of the cart 10 causing the sliding member 100 to similarly move toward the front of the cart 10 resulting in the actuating arm 102 attached to the sliding member 100 to disengage the dunnage retainer 90 causing the dunnage retainer 90 to rotate into its upright position.

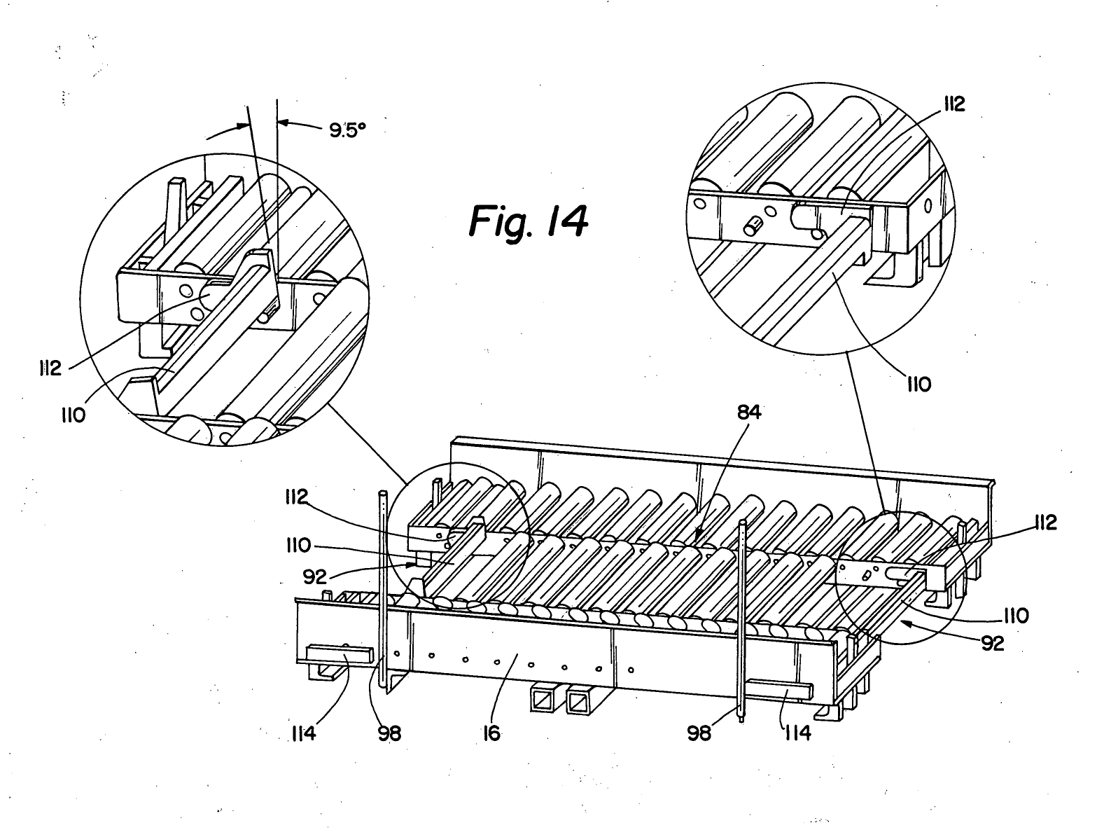

As shown in FIG. 14, dunnage retainers 92 comprise a bar member 110 rotatably attached to the frame member 16 by means of a bell crank assembly 112 and positioned at the oppositely disposed ends of the inner roller conveyor section 84. The bell crank assembly 112 can be rotated by means of a turn handle 114 that is attached to the bell crank assembly 112 by a shaft (not shown). In order for the dunnage retainer 92 to effectively to retain a load on the roller conveyor section 84, it has been found that the plane of the surface of the bar member 110 should be about 9.5 degrees outwardly offset from vertical. By rotating the turn handle 114, the bar member 110 is rotated so the plane of its surface is horizontal permitting a load to be placed onto or removed from the roller conveyor section 84.

Certain modifications and improvements will occur to those skilled in the art upon reading the foregoing. It is understood that all such modifications and improvements have been deleted herein for the sake of conciseness and readability, but are properly within the scope of the following claims.

1) An industrial type cart comprising a base member, a frame member, means for rotatably connecting said frame member to said base member and means for rotatably indexing said frame member with respect to said base member.

2) The cart as defined in claim 1 wherein said rotatably connecting means comprises a support member attached to said base member, said support member having a bore therein, and a post member attached to said frame member, said post member being rotatably received within said bore in said support member.

3) The cart as defined in claim 1 further including a first member attached to said base member and a second member attached to said frame member.

4) The cart as defined in claim 3 wherein said first member has a circular configuration having a first diameter and said second member has a circular configuration having a second diameter.

5) The cart as defined in claim 4 wherein said second diameter of said second member is slightly greater than said first diameter of said first member.

6) The cart as defined in claim 5 wherein said first and said second members are concentric with respect to one another.

7) The cart as defined in claim 3 wherein said first member is formed from metal tubing having a substantially square cross-section.

8) The cart as defined in claim 3 wherein said second member is formed from L-shaped angle iron.

9) The cart as defined in claim 3 wherein said first member is attached to the top surface of said base member and said second member is attached to the bottom surface of said frame member.

10) The cart as defined in claim 3 further including a plurality of bearings rotatably interconnecting said first member and said second member.

11) The cart as defined in claim 10 wherein said plurality of bearings comprises roller bearings, said roller bearings being rotatably attached to said first member permitting the rolling engagement of said roller bearings with said second member.

12) The cart as defined in claim 3 wherein said rotatable indexing means comprises a spring loaded pin arrangement attached to said base member and at least one complementary flange arrangement attached to said second member, said spring loaded pin arrangement engaging said at least one complementary flange arrangement when said frame member is rotatably indexed with respect to said base member.

13) The cart as defined in claim 12 wherein said at least one complementary flange arrangement comprises a pair of flanges in a spaced apart relationship forming a gap therebetween, said spring loaded pin arrangement being received within said gap when said frame member is rotatably indexed with respect to said base member.

14) The cart as defined in claim 1 further a roller conveyor arrangement attached to the top surface of said frame member.

15) The cart as defined in claim 14 wherein said roller conveyor arrangement comprises of pair of oppositely disposed roller conveyor sections having substantially the same length with a roller conveyor section having a different length interposed therebetween, the length of said oppositely disposed roller conveyor sections being greater than the length of said roller conveyor section interposed therebetween forming a roller conveyor arrangement having an H-shaped configuration.

16) The cart as defined in claim 14 wherein said roller conveyor arrangement comprises a plurality of roller conveyor sections having substantially the same length.

17) The cart as defined in claim 1 wherein said base member has a plurality of wheels mounted on the bottom surface thereof, each of said wheels being mounted at an approximate corner of said base member.

18) The cart as defined in claim 1 further including a handle member attached to said base member.

19) The cart as defined in claim 1 further including a tow bar rotatably attached to said base member.

20) The cart as defined in claim 13 further including means for retaining a load on said roller conveyor arrangement.

21) The cart as defined in claim 20 wherein said load retaining means comprises a rotatable retainer member positioned adjacent an end of said roller conveyor arrangement and means for actuating said rotatable retainer member.

22) The cart as defined in claim 21 wherein said actuating means comprises a linkage mechanism.
